(19) United States
(12) Patent Application Publication
(10) Pub. No.: US 2014/0052458 A1
(43) Pub. Date: Feb. 20, 2014

(54) TECHNIQUES FOR CUSTOMIZING AND DELIVERING WELLNESS PRODUCTS AND SERVICES

(71) Applicants: Kamyar Ghazvini, Wheeling, IL (US); Anna Ghazvini, Wheeling, IL (US)

(72) Inventors: Kamyar Ghazvini, Wheeling, IL (US); Anna Ghazvini, Wheeling, IL (US)

(73) Assignee: WellCube Healthcare Corporation, Wheeling, IL (US)

(21) Appl. No.: 13/589,582

(22) Filed: Aug. 20, 2012

(51) Int. Cl. G06Q 50/22

(52) U.S. Cl. 705/2

(57) ABSTRACT

Techniques for customizing and delivering wellness products and services are provided. A consumer is presented with wellness questions and supplies answers to those questions. Wellness products and services are resolved based on the answers. The consumer makes selections for the products and services and if the consumer is at a kiosk when making the selections the products and services are directly dispensed to the consumer. When the consumer is not at a kiosk, a key is delivered to the consumer and when the key is subsequently presented at the kiosk, the products and services are automatically dispensed from the kiosk.

### BACKGROUND

The wellness industry is a megatrend in the workings of business and economy. “Baby boomers” are the largest group of people that will significantly help various industries over the decades to come. More particularly, now that the baby boomers are in the later years of their lives, they are attending to their medical needs and are looking for ways to maintain their youth, vitality, and health.

Notwithstanding baby boomers, the general public at large is also more health conscious these days. Consumers are demanding better product labeling, more health-wise choices, alternative treatments and medicines, and more. In fact, the health industry is one of the few industries that are growing at near exponential rates.

Similarly, the industry trend with automated point-of-purchase is increasing. Consumers are using automated kiosks for a far wider range of goods and services than what was expected with the traditional vending machines. Kiosk usage has demonstrated an increase in the time people are willing to browse for products and services; and an increase in the variety of products and services that people are willing to purchase via a kiosk.

Furthermore, what is considered a “kiosk” is blurring. Nowadays, people can use their own portable devices (such as smart phones or tablets) as a kiosk. Additionally, it is not just the traditional Automated Teller Machine (ATM) that provides network connectivity to backend services, since nearly every kiosk today includes some form of network connectivity to other more comprehensive services.

As a result, consumers are demanding better health care options having more convenience and control when selecting and acquiring their desired health care products and services.

### SUMMARY

In various embodiments, techniques for customizing and delivering wellness products and/or services are presented. According to an embodiment, a method for delivering a customized wellness product and/or service is provided.

Specifically, a consumer interacts with a kiosk to provide answers to wellness questions that are presented to the consumer. The answers are used at the kiosk to resolve one or more wellness products presented to the consumer. The consumer makes one or more selections for the one or more wellness products and the kiosk dispenses the one or more selected wellness products to the consumer.

### BRIEF DESCRIPTION OF THE DRAWINGS

FIG. 1 is a diagram of a method for delivering a customized wellness product and/or service, according to an example embodiment.

FIG. 2 is a diagram of another method for delivering a customized wellness product and/or service, according to an example embodiment.

FIG. 3 is a diagram of a customized wellness delivery system, according to an example embodiment.

FIGS. 4A-4F are sample screen shots of a customized wellness delivery system, according to an example embodiment.

FIGS. 5A-5D are sample diagrams of selection logic for delivering customized wellness products and services, according to an example embodiment.

FIGS. 6A-6C are sample views of a kiosk having the customized wellness delivery system, according to an example embodiment.

### DETAILED DESCRIPTION

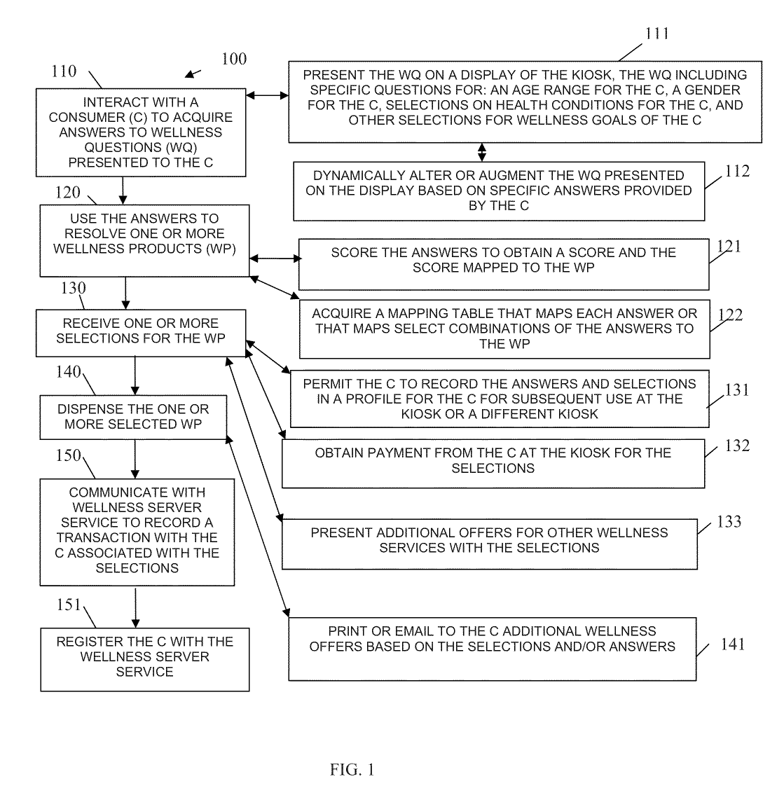

FIG. 1 is a diagram of a method 100 for delivering a customized wellness product and/or service, according to an example embodiment. The method 100 (hereinafter “customized wellness service”) is implemented as instructions programmed and reside on a non-transitory computer-readable (processor-readable) storage medium and executed by one or more processors (e.g., kiosk, etc.) over a network connection. In an embodiment, a kiosk includes one or more processors and memory, the memory having executable instructions for the customized wellness service and the one or more processors configured to execute the customized wellness service on the kiosk. So, the processors are specifically configured and programmed to process the customized wellness service. The customized wellness service operates over a network and the network is wired, wireless, or a combination of wired and wireless.

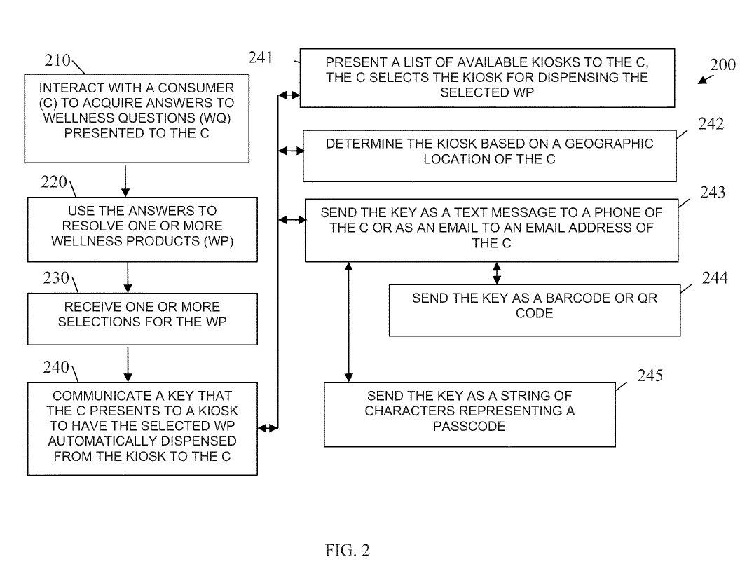

The customized wellness service includes a network connection to a wellness server service, discussed below with reference to the FIG. 2. The processing of the customized wellness service, as described here with reference to the FIG. 1 is from the perspective of a client kiosk machine having the customized wellness service. Moreover, the processing of the wellness server service, as will be discussed below with reference to the FIG. 2, is presented from the perspective of a server or cloud-based environment having the wellness server service.

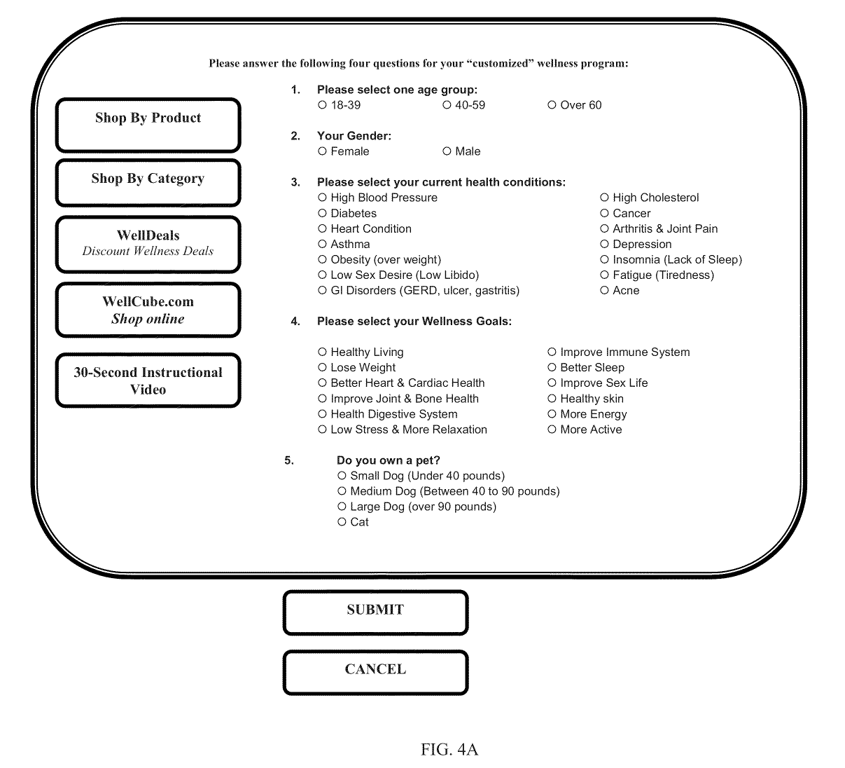

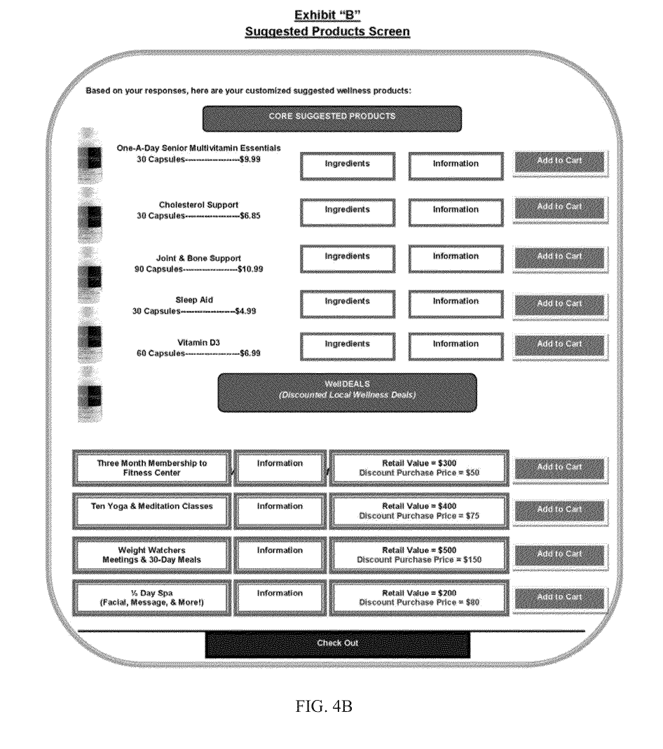

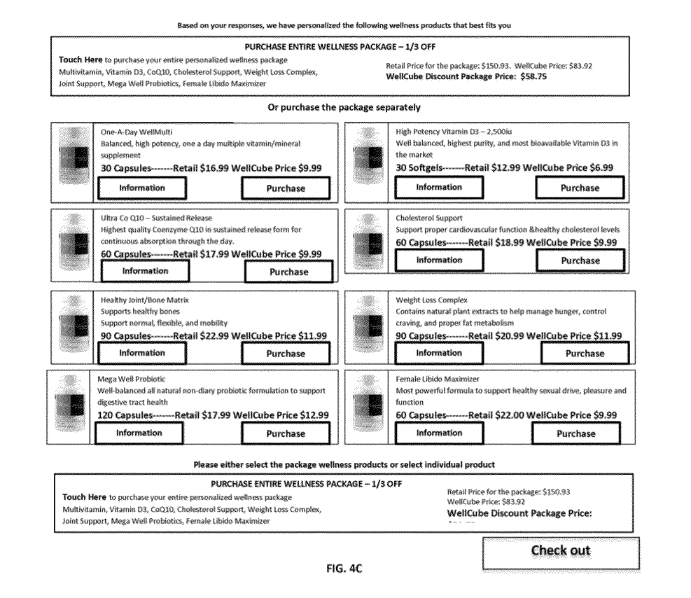

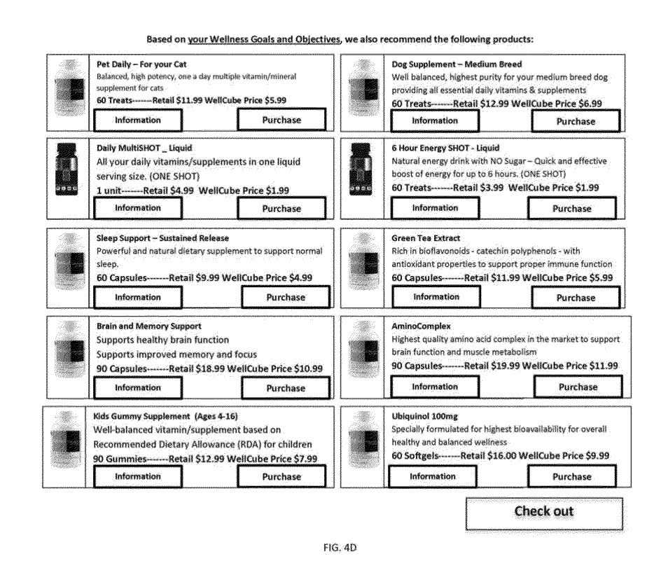

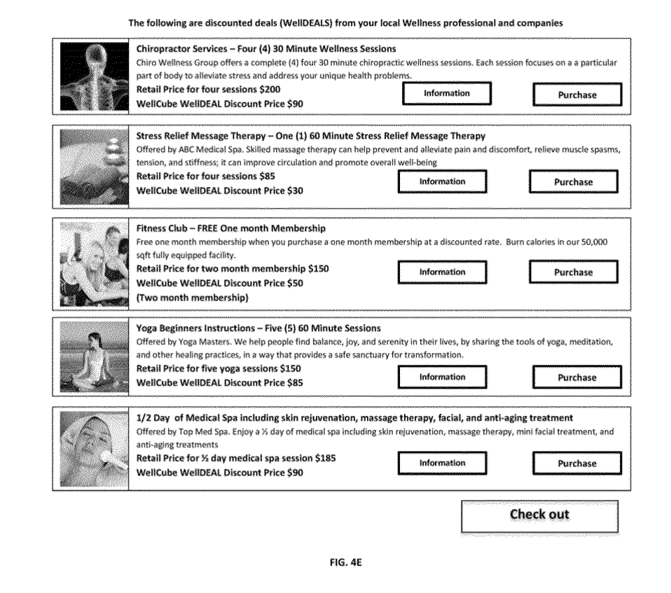

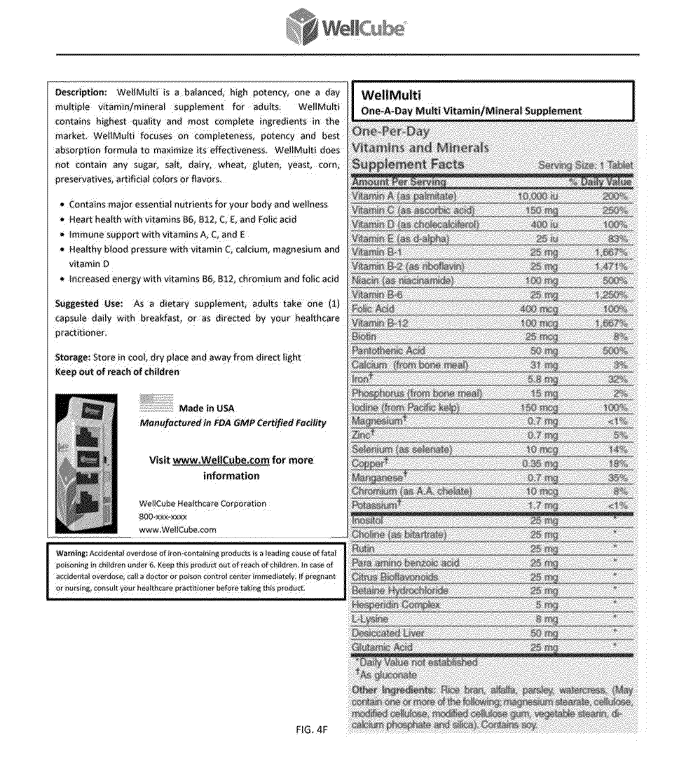

At 110, the customized wellness service interacts with a consumer to acquire consumer-supplied answers to one or more wellness questions. The questions asked can be customized and are presented on a display of the kiosk, which the consumer interacts with. Some specific questions are presented below with reference to the FIG. 4A.

According to an embodiment, at 111, the customized wellness service presents the wellness questions on a display of the kiosk where the wellness questions include specific questions for: an age range for the consumer, a gender for the consumer, selections on health conditions for the consumer, and other selections for wellness goals of the consumer.

Continuing with the embodiment of 111 and at 112, the customized wellness service dynamically alters or augments (with additional wellness questions) the wellness questions, which are presented on the display of the kiosk based on specific answers provided by the consumer during interactions. So, as an example, the gender of the consumer may change the health condition questions asked of the consumer. The point is that questions can be dynamically changed or added based on specific answers being supplied by the consumer.

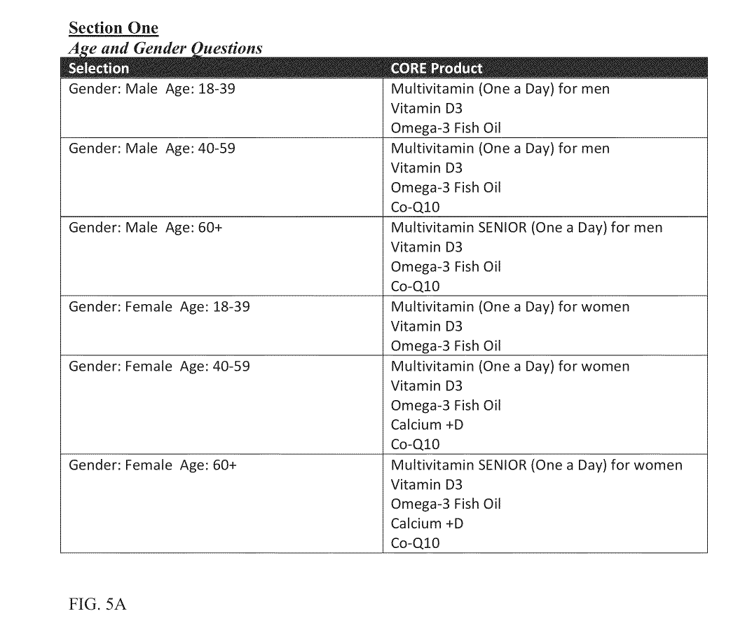

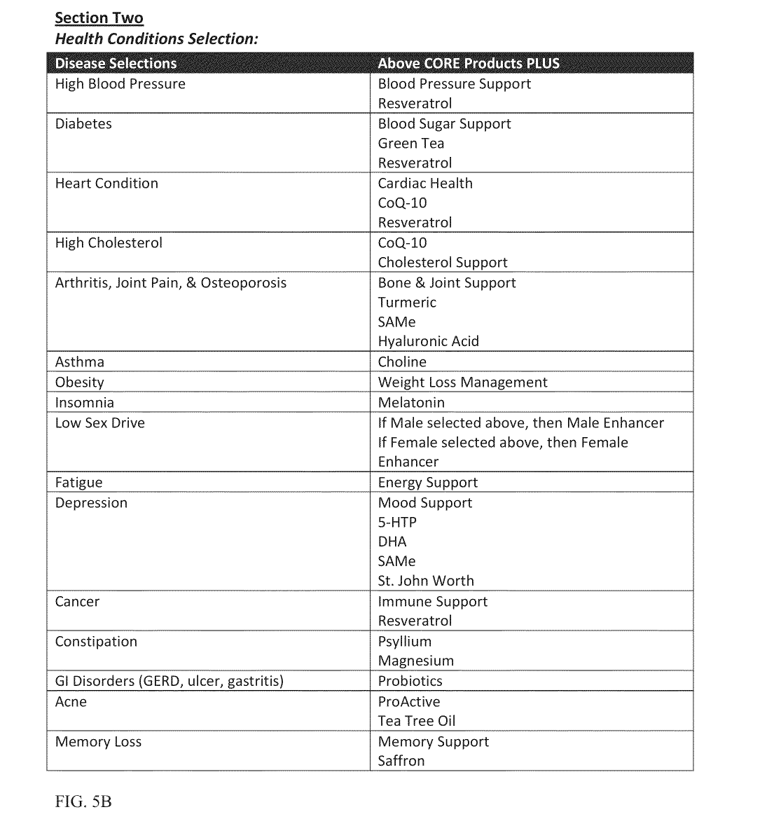

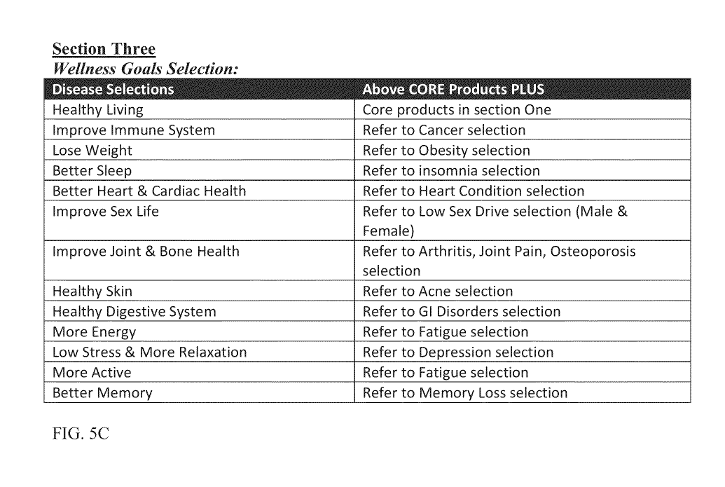

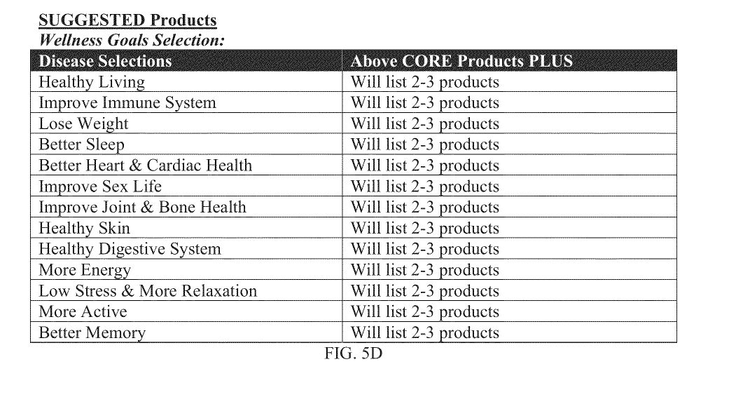

At 120, the customized wellness service uses the answers to resolve one or more suggested wellness products for the consumer and available via the kiosk that the customized wellness service processes on. Some example specific logic for making selections based on specific answers or specific subsets or combinations of answers to the wellness questions are presented below with reference to the FIGS. 5A-5D.

According to an embodiment, at 121, the customized wellness service scores the answers to obtain a score and that score is then mapped to the one or more suggested wellness products.

In another case, at 122, the customized wellness service acquires a mapping table that maps each answer or that maps select combinations of the answers to the one or more wellness products.

At 130, the customized wellness service receives one or more selections for the one or more wellness products. Here, the consumer selects one, some, or all of the suggested wellness products for dispensing via the kiosk.

In an embodiment, at 131, the customized wellness service permits the consumer to record the answers and/or the selections in a profile for the consumer for subsequent use at the kiosk or at different kiosks. Here, the customized wellness service interacts with a wellness server service (such as the one described below with reference to the FIG. 2) to perform the registration and create the profile for the consumer.

In another situation, at 132, the customized wellness service obtains payment from the consumer at the kiosk for the selections. Payment can be made via cash, credit card, gift cards, etc. Moreover, coupons or loyalty rewards may be applied before payment is collected for the selected wellness products.

In yet another case, at 133, the customized wellness service presents additional offers for other wellness services with the selections.

At 140, the customized wellness service dispenses from the kiosk the one or more selected wellness products. So, custom wellness products are interactively identified based on questions posed to the consumer and dispensed to the consumer during a same transaction with the kiosk.

According to an embodiment, at 141, the customized wellness service prints or emails to the consumer additional wellness offers based on the answers and/or selections for the wellness products.

In an embodiment, at 150, the customized wellness service communicates, via the kiosk, with a wellness server service to record the transaction with the consumer associated with the selections for the wellness products.

Continuing with the embodiment of 150 and at 151, the customized wellness service registers the consumer with the wellness server service.

The customized wellness service utilizes dynamic interactive communication between a kiosk and a consumer interacting with the screens presented by the customized wellness service on the kiosk. So, the interactive screens managed and presented by the customized wellness service create a dynamic and real-time dialogue between the consumer and the customized wellness service via the kiosk. On the backend the customized wellness service dynamically communicates with the wellness server service (discussed below with reference to the FIG. 2); this results in specific wellness products and services being recommended to the consumer and creates a customized customer or consumer experience for wellness information, wellness services, and wellness products; all of which can be custom vended through the kiosk with which the consumer is dynamically interacting with. In some instances, if a particular product is unavailable from the kiosk for immediate vending, then the customized wellness service can interact with the wellness server service to order the product for the consumer for home deliver or for dispensing from a different kiosk known to have the product (a key can be used to retrieve that product from the different kiosk). In some embodiments, the desired product may even be reserved for the consumer such that another consumer cannot acquire the product from the kiosk if said product is a last one available at the dispensing kiosk. In other words, the customized wellness service can be used on a first kiosk to locate a desired product on a second kiosk and then have that product reserved on the second kiosk for just the consumer. This can be achieved via interaction between the first and second kiosks and their instances of the customized wellness service with the wellness server service.

FIG. 2 is a diagram of another method 200 for delivering a customized wellness product and/or service, according to an example embodiment. The method 200 (hereinafter “wellness server service”) is implemented as instruction and programmed within a non-transitory computer-readable (processor-readable) storage medium that executes on one or more processors of a server (e.g., cloud processing environment, etc.); the processors of the server are specifically configured to execute the wellness server service. The wellness server service is also operational over a network; the network is wired, wireless, or a combination of wired and wireless.

The wellness server service interacts with the client-based (kiosk-based) customized wellness service (discussed above with reference to the FIG. 1) to provide novel techniques for customizing and delivering wellness products and/services to consumers.

At 210, the wellness server service interacts with a consumer to acquire answers to wellness questions that are presented to the consumer. These questions are presented over a web-based interface accessible via a browser and accessed by a user via a processing device, such as a computer, a laptop, a tablet, the user's phone and others. The same look and feel of the questions can be presented over the web-based interface of the wellness server service as was presented above on the kiosk for the customized wellness service.

At 220, the wellness server service uses the answers to resolve one or more wellness products. The manner in which this is achieved is similar to what was discussed above with respect to the customized wellness service of the kiosk. Moreover, some specific selection logic for resolving suggested wellness products based on user-supplied answers is presented below with reference to the FIGS. 5A-5D.

At 230, the wellness server service receives one or more selections for the one or more suggested wellness products. Again, this process for receiving the selections is similar to what was discussed above with respect to the customized wellness service of the kiosk.

At 240, the wellness server service communicates a key that the consumer presents to a kiosk to have the selected one or more wellness products automatically dispensed from the kiosk to the consumer. This key provides an automated mechanism for transacting with the kiosk. Moreover, it is noted that the kiosk-based implementation of the customized wellness service for the FIG. 1 includes a mode of operation where the key is presented and selected wellness products are automatically dispensed to the consumer.

According to an embodiment, at 241, the wellness server service presents a list of available kiosks to the consumer. The consumer then selects the kiosk for dispensing the selected one or more wellness products. So, the key in some instances can include information that identifies a specific dispensing kiosk.

In another instance, at 242, the wellness server service determines the kiosk based on a geographic location of the consumer. That is, the consumer may be transacting with the wellness server service via a smart phone and the geographical location automatically ascertained from the communications and that geographical location used to select an available kiosk for dispensing the selected wellness products within a predefined geographical range. It is also noted that a profile of the consumer registered with the wellness server service can define an acceptable geographical range to use with the consumer.

It is noted that a variety of other mechanisms can be used by the wellness server service to select a specific kiosk or set of kiosks that can dispense the selected wellness products. For example, a profile of the consumer may provide rules that are dynamically evaluated by the wellness server service to resolve a specific kiosk. Alternatively, stores with premium subscriptions to the wellness server service may be designated over other stores that have available kiosks for dispensing the selected wellness products.

In an embodiment, at 243, the wellness server service sending the key as a text message to a registered phone of the consumer or sending the key as an email or email attachment to a registered email address of the consumer.

Continuing with the embodiment of 243 and at 244, the wellness server service sending the key as a barcode or Quick Response (QR) code within the text message or the email.

Still continuing with the embodiment of 243 and at 245, the wellness server service sends the key as a string of characters representing a passcode in the text message or the email message.

The key can be sent in other formats as well. For example, the key may be send as a Near Field Communication (NFC) key to a phone of the consumer that is NFC enabled. The consumer then taps his/her phone to the kiosk (also NFC enabled) to dispense the selected wellness products.

A variety of other features of the wellness server service should be noted as well for purposes of appreciating the techniques presented herein and for purposes of describing additional benefits and capabilities of the techniques presented herein.

The wellness server service:
Mimics the interactive screen of the customized wellness service provided on the kiosk and as described above with reference to the FIG. 1.
Provides the ability to use the executable software instructions to customize/personalize wellness products/services based on customers responding to set of questions; similar to the customized wellness service of the FIG. 1.
Expands the list of available products and services beyond what is provided with the customized wellness service of the FIG. 1 (kiosk-based implementation. For instance, the kiosk may contain 60-75 products whereas the wellness server service (may also be referred to herein as “the WellCube ecommerce site” may carry several hundred products.
When a customer purchases products from the Kiosk having the customized wellness service of the FIG. 1:
   An automated email is sent to the customer with copy of receipt, information on each product purchased and a link to wellness server service (e.g., WellCube.com) for the customer to register.
   Once a customer registers on the WellCube.com, the customer is able to start using a customer-registered user ID and password combination to login onto the site or any other WellCube kiosk having the customized wellness service of the FIG. 1
   Customers can enter their prescription medications, which cross references products purchased through WellCube.com or Kiosk (via the customized wellness service (kiosk) or the wellness server service (website)). The backend database, in some instances, is third-party software integrated into the website.
During registration process, customers are able to select the following email communications to receive from the wellness server service:
   a Daily Wellness tips;
   a Weekly specials, coupons, product and other news; and/or
   A monthly newsletter.
Refill reminders can be automatically processed on behalf of the customers based on the product quantity and regimen; so, the customer receives a refill reminder to purchase a product a week before the customer runs out of the product. For example, if a customer purchases a daily, multi-vitamin with 60 capsules to be taken once daily, the customer receives an automated email 53 days after the purchase date indicating that it is time to refill his/her multi-vitamin. This communication can also include links for coupons, etc. in the email that the customer can click and purchase: refills directly, other products and services, etc.
If the initial purchase initiates from a WellCube kiosk (a kiosk having the customized wellness service of the FIG. 1), all future purchases from the customer can be linked to the original WellCube kiosk. This can be done to share a portion of revenue with our partners associated with an original seller.
WellCube Navigator—This feature on the wellness server service allows customers to locate a closest WellCube kiosk having the customized wellness service of the FIG. 1.
WellDeals—Wellness companies and vendors can offer discount wellness deals through the WellCube kiosk (kiosk having the customized wellness service of the FIG. 1) and WellCube.com (server having the wellness server service). Customers can navigate the WellDeals based on location (city/state or zip code) or by WellDeal categories.

### Other Functions

Automated registration process
Automated shopping cart for first purchase, such as a OnceClick purchase for registered users (one click to buy and checkout)
Each product includes an image with ingredients and brief description
Customer can purchase products online and have the option to get the products shipped or can arrange to pick up the products from one of the WellCube kiosks (this can be done from one kiosk to another kiosk as well, which was described above with reference to the FIG. 1). This can be accomplished as follow:
   If customer selects to pick up purchased products at a kiosk rather than products being shipped, there are instructions sent via email. The instructions to pick up products from a WellCube kiosk (each reference herein to “WellCube kiosk is to a kiosk having the customized wellness service of the FIG. 1) may include an order confirmation number that can be used at the kiosk used for pickup of the products.
   Customers have the ability to locate the closest WellCube kiosk by search location option.
   Once a customer is at the kiosk, the customer enters the UserID, password and the order confirmation number to get the products through the WellCube kiosk. This is one embodiment as others were described herein that can be used as well.
   If a customer forgets the password/userID or other personal information, the forgotten information can be sent to a cell phone via text or email to the customer.
Ability to update the site including pricing, specials, new products, deleting products, etc.
A “Live Customer Service” interaction feature.

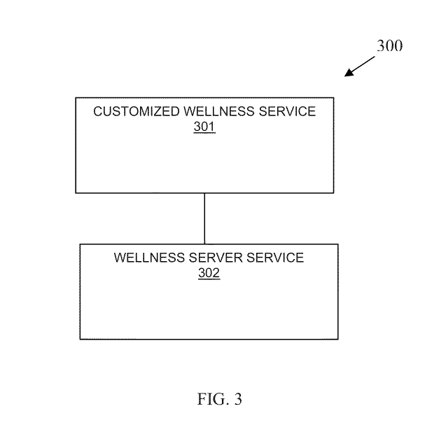

FIG. 3 is a diagram of a customized wellness delivery system 300, according to an example embodiment. The components of the customized wellness delivery system 300 are implemented as executable instructions and programmed within a non-transitory computer-readable (processor-readable) storage medium that execute on one or more processors of a client machine (kiosk) and a server machine (cloud-based processing environment; the processors are specifically configured to execute the components of the customized wellness delivery system 300 from the non-transitory computer-readable storage media and/or from memories associated with both the client machine and the server machine. The customized wellness delivery system 300 is also operational over a network; the network is wired, wireless, or a combination of wired and wireless.

The customized wellness delivery system 300 includes a customized wellness service 301 and a wellness server service 302. Each of these components and the interactions of each component are now discussed in turn.

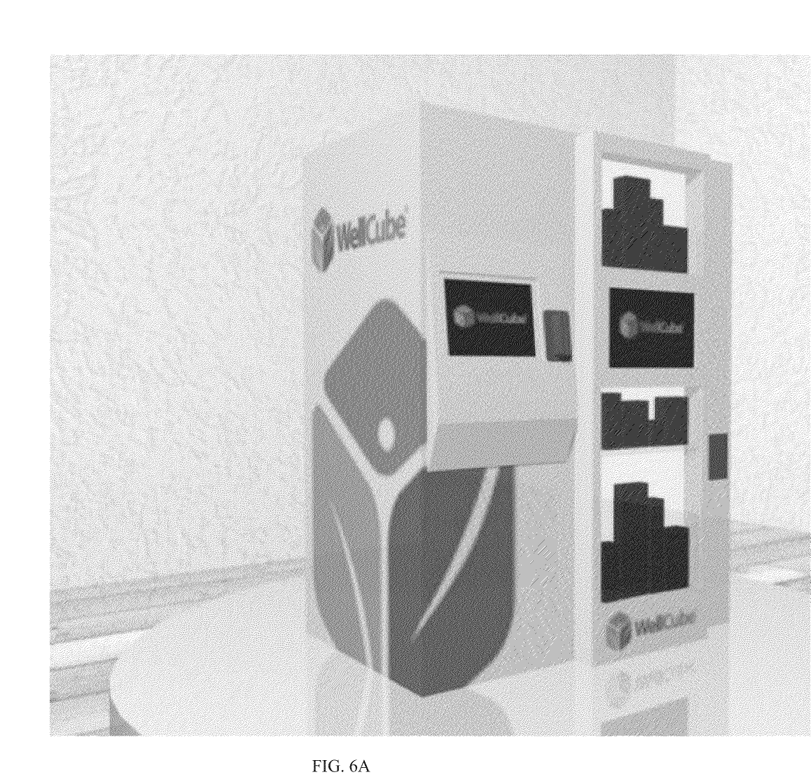

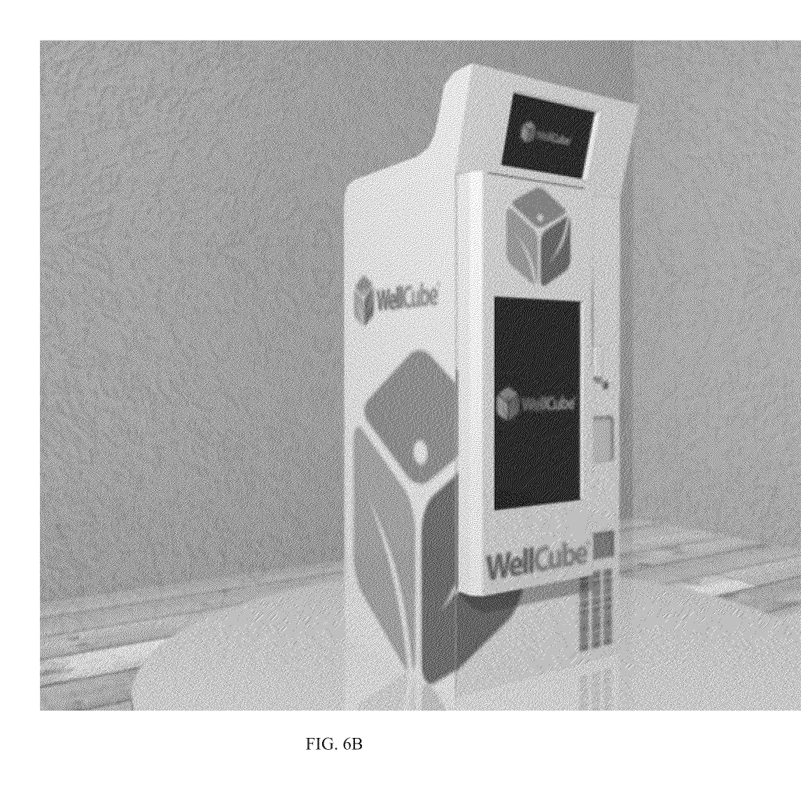

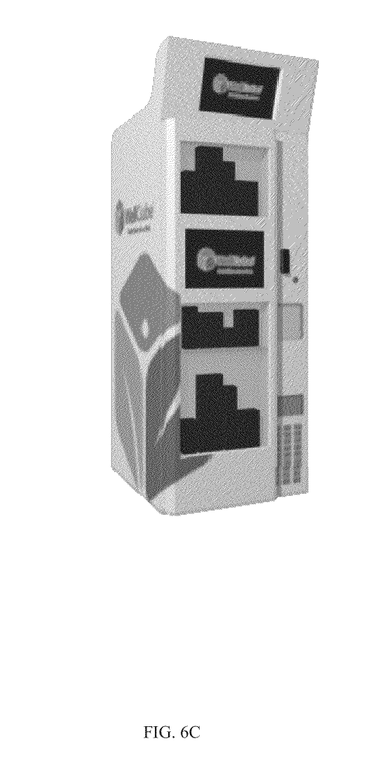

The customized wellness delivery system 300 includes a client machine having one or more processors and memory. The memory is configured with executable instructions for the customized wellness service 301, which resides in a non-transitory computer-readable storage medium accessible to the client machine. In an embodiment, the customized wellness service 301 operates on a client machine that is a kiosk, such as the sample kiosk described below with reference to the FIGS. 6A-6C. Example processing associated with the customized wellness service 301 was presented in detail above with reference to the FIG. 1.

The customized wellness service 301 is configured to interact with a consumer to resolve customized wellness products and/or services. This can be achieved via the question and answer session as described in the FIG. 1 or this can be achieved via communication of a key associated with a prior transaction between the consumer and the wellness server service 302 (as described above with the FIG. 2). So, the key may be scanned as a barcode or QR code by a scanner or camera of the kiosk; may be delivered via a NFC tap, or may be entered via an input device as a passcode.

According to an embodiment, the customized wellness service 301 is also configured to print a receipt (or text message or email the receipt) from the kiosk. The receipt shows products or services within a store where the kiosk is situated and the receipt may also optionally include a map for the store showing where other products that may be of interest to the consumer are located. This may show the aisle and shelf location as well and may be an image map, written directions, or both.

The customized wellness delivery system 300 also includes a server machine having one or more processors and memory. The memory is configured with executable instructions for the wellness server service 302, which resides in a non-transitory computer-readable storage medium accessible to the server machine. In an embodiment, the wellness server service 302 operates on a server machine that is a remote cloud processing environment. Example processing associated with the wellness server service 302 was presented in detail above with reference to the FIG. 2.

The wellness server service 302 is configured to interact with the consumer to resolve customized wellness products and/or services for the consumer. Again, this is achieved via an interactive question and answer session between the consumer and the wellness server service 302, via a web browser used on a device of the consumer. The wellness server service 302 then delivers a key to the consumer via a variety of mechanisms, printed receipt (printed from a printer accessible to the device of the consumer, via text message, via email message, and the like. The key uniquely identifies the consumer and the specifics of the transaction where the consumer selected one or more suggested wellness products and/or services for purchase.

According to an embodiment, the wellness server service 302 is configured to register and maintain a loyalty program with the wellness server service 302 for the consumer based on interactions with the kiosk and the server. Points and rewards may be associated with the loyalty program, such that consumers can redeem points as rewards for wellness goods and services.

FIGS. 4A-4F are sample screen shots of a customized wellness delivery system, according to an example embodiment.

Specifically, the FIG. 4A shows an example screen shot of a kiosk-based or server-based implementation of the customized wellness service (FIG. 1) or wellness server service (FIG. 2) where an initial home screen is presented to the consumer and some specific wellness questions are asked of the consumer.

It is noted that pet questions may be asked as well (presented as item 5 in the FIG. 4A). Here, based on the consumer's selection of a type of pet and size of dog, a recommendation for wellness products (such as vitamins and supplements) are made to the consumer (some of which is shown in the FIG. 4D). Moreover, based on the answers or selections made for the pet questions on the FIG. 4A a list of wellness deals from local pet-related businesses can also be recommended to the consumer. Again, such information can be available on the kiosk-based implementation with the consumer and on the website via the website service. It is also noted that the website may include expanded lists for pet services and products some of which may not be available via the kiosk-based implementation.

The FIG. 4B shows an example screen shot of a kiosk-based or server-based implementation of the customized wellness service (FIG. 1) or the wellness server service (FIG. 2) where some sample wellness products and services are offered to the consumer based on answers provided by the consumer with respect to the questions of the FIG. 4A.

The FIGS. 4C and 4D shows different example screen shots (from that which was presented in the FIG. 43) of a kiosk-based or server-based implementation of the customized wellness service (FIG. 1) or the wellness server service (FIG. 2) where some sample wellness products and services are offered to the consumer based on answers provided by the consumer with respect to the questions of the FIG. 4A.

The FIG. 4E illustrates some example wellness deals and offers that may be presented to the consumer as well during the checkout process or at other points in the interaction with the consumer.

The FIG. 4F illustrates an example set of information for a wellness product offering (presentable or rendered to a single viewable page). This can be implemented as a pop-up window, such that when the consumer touches an information button (as presented in the FIGS. 4B-4E) specific product or service information is presented to the consumer. Such information can be presented on the kiosk or via the website service. Moreover, the detailed product information depicted in the FIG. 4F can also be emailed or texted to the consumer after the consumer makes a purchase for the specific product to which the detailed product information relates.

FIGS. 5A-5D are sample diagrams of selection logic for delivering customized wellness products and services, according to an example embodiment.

Specifically, some example wellness product offerings carried in the kiosk and available for delivery via the kiosk are shown in the FIG. 5A based on age ranges and gender selections made with respect to the questions provided in the FIG. 4A.

In the FIG. 5B, sample wellness products that are available for delivery via the kiosk are presented based on selections of questions related to a consumer's health condition (as presented in the FIG. 4A).

The FIG. 5C, shows to how selections to previous presented wellness products (displayed in the FIGS. 5A and 5B) are made based on selections for wellness goals (presented in the FIG. 4A with the wellness questions).

Now that context has been provided for specific wellness questions and selections of specific wellness products a sample scenario with the consumer is presented for purposes of illustration.

In a scenario, if a customer does not select an option in health conditions, but selects a wellness goal that refers to a health condition, the CORE products in the health condition is displayed. For example, a customer may NOT select “Cancer” as a health condition, but selects “Improve Immune System” in the Wellness Goals section. Since “Improve Immune System” reverts back to Cancer, CORE products in Cancer will be displayed.

A few points should be noted:
Above Selections will result in list of CORE products, which will allow a customer to purchase as a package or select individually.
If there are multiple selections, there cannot be duplicate products in the list of CORE products. Customers may select multiple health conditions and wellness goals where the results yield duplicate products. In this case, the system does not display duplicate products.
The illustration is presented for ease of comprehension and it is noted that there are more products in each category, but essentially the logic presented herein for resolving products is similar.
The look and feel of the presented interactive screens can be similar to ecommerce websites permitting easy navigation and user friendly prompts. The colors, graphics, product pictures, and design can be made vivid and clear with well-organized processes.
For each CORE product listed, the customer has the option to select individually. There are also two options for a customer to view the ingredient and information for each product. Customers can touch either the ingredient button to see the ingredients or information button to learn more about each product. When a customer touches each button, a pop up informational box provides the product ingredient or information. Customers can then close the pop up window and go back to product screen.
Once the customer selects either individual CORE products or the entire package, the NEXT button takes the customer to WellCube Wellness Deals.

There are also deals and offers to other related wellness goods and services.

As an example, consider wellness deals (WellDeals). Depending on the number of wellness businesses placing discounted deals in WellCube, the deals are arranged within the display presented to the user using the interactive software.

### Options:

1. If less than 10-12 (or as many as will fit on one screen) wellness deals, the deals are listed on the screen. Customers have the option to learn more about, each deal by touching information. The information is in a pop up window similar to above vitamin information. Customers have an option to add to their carts.
2. If there are more wellness deals than can fit on a single screen, categories are set up for presentation for the deals. For example, Chiropractor deals, message deals, fitness deals, etc.

Customer can skip the WellDeals and go to NEXT page, which will include the SUGGESTED PRODUCTS based on responses to questions related to wellness goals.

The FIG. 5D shows logic for presenting wellness products based on disease selections. The suggested products are the last screen presented to the customer before checkout. The suggested products are listings of 2-3 products (those not listed in the CORE products) and are linked to wellness goal selections. Moreover, the suggested products are different from the ones that are listed in the CORE product offerings.

Some other features related to checkout and the customized wellness service (FIG. 1) and the wellness server service (FIG. 2) are now presented for additional illustration.

During the checkout processing:
1) All selected products and WellDeals are individually listed with option to remove from shopping cart.
2) Customers press PURCHASE to buy the selected products. At this screen (very similar to an ecommerce site), the customers enter billing and shipping information (plus email) to purchase products. In some instances this may be automatically achieved by reading the magnetic credit cards of the consumers when swiped.
3) The last screen prompts the customers to get purchased products through WellCube (vending) or have it shipped.

Some other features of the customized wellness service and the wellness server service include:
A) The home page screen has the wellness assessment as the default page. There are options for customers to:
   1. Shop by category
   2. Shop by product
   3. Link to WellCube.com to purchase online and have products shipped to them (NO VENDING)
   4. Special offers/discounts—list of special offers (discounts, buy one get one free, etc.) offered from our suppliers
   5. We can also provide a 20-30 second video about WellCube and quick instructions. This video will also run in-between vendor advertising in the digital ad screen.
B) After purchase, an automated email consisting including the following is sent to customer:
   1. Purchase receipt
   2. Product information for each product purchased
   3. Link to Wellcube.com website for customer to register
C) After customer registers on the website, the customer gets a unique UserID and Password for access to the wellness server service.
   1) The UserID and Password can be used at any of the WellCube interactive Kiosks for customers to login and navigate or purchase products. If a customer logs into the WellCube kiosk, all his/her information is populated in the checkout screen. This allows for a quick checkout (similar to Amazon® and other major sites).
   2) When a customer logins into the WellCube.com website, he/she is able to input his/her other medications (prescription and non-prescription medications). The system is able to provide a drug-drug; drug-supplement, and drug-food interaction report. The customer is also able to manage his/her accounts, review purchases, set up AutoRefill for the products purchased, and the like.
D) Vitamin vendors (suppliers) can offer discounts including percentage off, buy one get one free, and other specials through the kiosk. Vendors can advertise their special offers in the WellCube digital ad screen. Products with special offers/discounts have the offer next to them when they are displayed. Customers also have a choice to select a list of special offers/discounts by touching the “Special offer/discount” button.

It is noted that the server processing can be integrated into other popular purchasing sites, such as Amazon® and others.

FIGS. 6A-6C are sample views of a kiosk having the customized wellness delivery system, according to an example embodiment. It is noted that the kiosks are shown as an example, since other designs can be used without departing from the teachings presented herein. Moreover, the kiosks shown in the FIGS. 6A-6C include one or more processors and memory having the customized wellness service and a network connection providing communications with the wellness server service, which may be processing in a remote cloud environment over the network.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A processor-implemented method programmed in a non-transitory processor-readable medium and to execute on one or more processors of a kiosk configured to execute the method, comprising:
interacting, via the kiosk, with a consumer to acquire answers to wellness questions presented to the consumer;
using, at the kiosk, the answers to resolve one or more wellness products;
receiving, at the kiosk, one or more selections for the one or more wellness products; and
dispensing, from the kiosk, the one or more selected wellness products.

2. The method of claim 1, wherein interacting further includes presenting the wellness questions on a display of the kiosk, the wellness questions including specific questions for: an age range for the consumer, a gender for the consumer, selections on health conditions for the consumer, and other selections for wellness goals of the consumer.

3. The method of claim 2, wherein presenting further includes dynamically altering or augmenting the wellness questions presented on the display, based on specific answers provided by the consumer.

4. The method of claim 1, wherein using further includes scoring the answers to obtain a score and the score mapped to the one or more wellness products.

5. The method of claim 1, wherein using further includes acquiring a mapping table that maps each answer or that maps select combinations of the answers to the one or more wellness products.

6. The method of claim 1, wherein receiving further includes permitting the consumer to record the answers and selections in a profile for the consumer for subsequent use at the kiosk or a different kiosk.

7. The method of claim 1, wherein receiving further includes obtaining payment from the consumer at the kiosk for the selections.

8. The method of claim 1, wherein receiving further includes presenting additional offers for other wellness services with the selections.

9. The method of claim 1, wherein dispensing further includes printing or emailing to the consumer additional wellness offers based on the selections and/or the answers.

10. The method of claim 1 further comprising, communicating, via the kiosk, with a wellness server service to record a transaction with the consumer associated with the selections.

11. The method of claim 10, wherein communicating further includes registering, via the kiosk, the consumer with the wellness server.

12. A processor-implemented method programmed in a non-transitory processor-readable medium and to execute on one or more processors of a server configured to execute the method, comprising:
interacting, via the server, with a consumer to acquire answers to wellness questions presented to the consumer;
using, at the server, the answers to resolve one or more wellness products;
receiving, at the server, one or more selections for the one or more wellness products; and
communicating, from the server, a key that the consumer presents to a kiosk to have the selected one or more wellness products automatically dispensed from the kiosk to the consumer.

13. The method of claim 12, wherein communicating further includes presenting a list of available kiosks to the consumer, wherein the consumer selects the kiosk for dispensing the selected one or more wellness products.

14. The method of claim 12, wherein communicating further includes determining the kiosk based on a geographic location of the consumer.

15. The method of claim 12, wherein communicating further includes sending the key as a text message to a phone of the consumer or as an email to an email address of the consumer.

16. The method of claim 15, wherein communicating further includes sending the key as a barcode or Quick Response (OR) code.

17. The method of claim 15, wherein communicating further includes sending the key as a string of characters representing a passcode.

18. A system comprising:
a kiosk configured with a customized wellness service implemented within a non-transitory computer-readable storage medium and that executes on one or more processors of the kiosk; and
a server configured with a wellness server service implemented within a non-transitory computer-readable storage medium and that executes on the one or more processors of the server;
wherein the customized wellness service and the wellness server service are each configured to interact with a consumer to resolve customized wellness products or services for the consumer, and wherein the wellness server service is configured to deliver a key for the customized wellness products or services that when presented to the customized wellness service causes the kiosk to dispense the customized wellness products or services, and the customized wellness service configured to dispense the customized wellness products or service independent of the key based on interactions with the consumer.

19. The system of claim 18, wherein the customized wellness service is further configured to print a receipt from the kiosk showing products of interest within a store where the kiosk is situated and a map of the store for where those products of interest are located within the store.

20. The system of claim 18, wherein the wellness server service is configured to register and maintain a loyalty program with the wellness server service for the consumer based on interactions with the kiosk and the server.
